(19) United States
(12) Patent Application Publication
(10) Pub. No.: US 2025/0322231 A1
(43) Pub. Date: Oct. 16, 2025

(54) METHOD AND SYSTEM FOR AI-ENABLED AUTO HEALING OF NETWORK CELL SITE PERFORMANCE AND EXPERIENCE

(71) Applicant: Verizon Patent and Licensing Inc., Basking Ridge, NJ (US)

(72) Inventors: Navin Dalavai Premkumar, Chennai (IN); Ajaya Kumar Rout, Telangana (IN)

(73) Assignee: Verizon Patent and Licensing Inc., Basking Ridge, NJ (US)

(21) Appl. No.: 18/636,781

(22) Filed: Apr. 16, 2024

(51) Int. Cl. G06N 3/08

(52) U.S. Cl. CPC G06N 3/08

(57) ABSTRACT

The present teaching relates to AI-enabled auto-heal of network cells. Bundled embedding models are obtained, via machine learning, based on historic records representing knowledge on past dynamics of a network. Each of the bundled embedding models captures a respective aspect of the past network dynamics. When temporal data is received with real time observations of the network operation, metrics on the performance thereof, and a point of failure, embeddings of the temporal data relating to the point of failure are derived, based on the bundled embedding models, and used to generate, by time series forecasting, a recommendation on an auto-heal resolution. When performance information of the network associated with the point of failure is received, it is used for online learning of learnable parameters associated with the time series forecasting.

### BACKGROUND

Today's society relies on seamless network connections. Network failures impact many, which may lead not only to unsatisfactory user experience but also may cause loss of revenue for businesses. In some situations, although failures are detected in the network, the root cause may be difficult to establish, since it is located elsewhere due to a causal chain effect in the highly connected network. Given that, when network failures do occur, quickly detecting root causes and solving the problems in a prompt manner are critically important to bringing the network back to normal operation quickly.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for AI-enabled network auto-healing, in accordance with an embodiment of the present teaching;

FIG. 1B is a flowchart of an exemplary process for an AI-enabled network auto-healing framework, in accordance with an embodiment of the present teaching;

FIG. 2A illustrates exemplary types of information from historic records related to a network, in accordance with an embodiment of the present teaching;

FIG. 2B illustrates exemplary types of resolutions automatically recommended based on knowledge learned from historic records, in accordance with an embodiment of the present teaching;

FIG. 2C shows a typical timeline for resolving a network failure according to the state of the art;

FIG. 2D shows an enhanced timeline to resolve a network failure, in accordance with the present teaching;

FIG. 3A depicts an exemplary high level system diagram of a knowledge representation generator, in accordance with an embodiment of the present teaching;

FIG. 3B shows exemplary types of embedding models included as bundled embedding models, in accordance with an embodiment of the present teaching;

FIG. 3C is a flowchart of an exemplary process for a knowledge representation generator, in accordance with an embodiment of the present teaching;

FIG. 4A depicts an exemplary high level system diagram of a knowledge-based auto-heal recommender, in accordance with an embodiment of the present teaching;

FIG. 4B is a flowchart of an exemplary process for a knowledge-based auto-heal recommender, in accordance with an embodiment of the present teaching;

FIG. 5 shows an exemplary implementation of a next action recommender, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

In a modern network, communication service providers (CSP) have a need to industrialize the network cell site performance to deliver satisfactory experiences to users. Different types of failures may occur, including incidents related to platform resources (memory, computer, storage devices, etc.), data (data quality, data availability, etc.), pipelines (e.g., workflow interruption, inconsistencies in orchestration, etc.). A network failure needs to be resolved as promptly as possible. A mean time to detect (MTTD) metric and mean time to resolve (MTTR) metric are representative of how quickly a network failure may be detected and resolved. To minimize negative impact, the smaller these metrics are, the better it is for the network. However, there are challenges. For instance, network information received from cell sites may not be complete or accurate enough to be utilized effectively to enhance network performance. In addition, whether a solution deployed to resolve a failure is working or whether there is an interim failure may be difficult to detect due to lack of detailed observability. Furthermore, it may be hard to know when quality issues are occurring in the network or whether health scores have since further degraded. As such, the network information received may represent incorrect health scores and, thus, may not be reliable. That is, detecting an issue correctly may take time. On top of that, ascertaining which resolution may be deployed to fix an issue may take even a longer time due to the lack of observability of the effect because of the above issues.

The present teaching is directed to a framework for AI-enabled network auto-healing. The framework according to the present teaching comprises two phases. The first phase is related to knowledge gathering based on past historic records and constructing AI-based models to capture such knowledge via machine learning. In some embodiments, knowledge may be learned based on historic records to construct a knowledge graph, which may then be used for knowledge modeling via knowledge graph embeddings. The second phase is to utilize these AI-based models to recommend auto-heal measures with respect to network failures as well as time series data related to the network operation collected in real time and to deploy the recommended measures to automatically heal the network failures. In some embodiments, artificial neural network (ANN) with the capability of memorizing contextual information in a time series may be utilized to perform time series forecasting based on real time operational data as well as output of knowledge models, etc. to make auto-heal recommendations. Some of the recommended auto-heal measures may be automatically activated and some may be deployed by network operators.

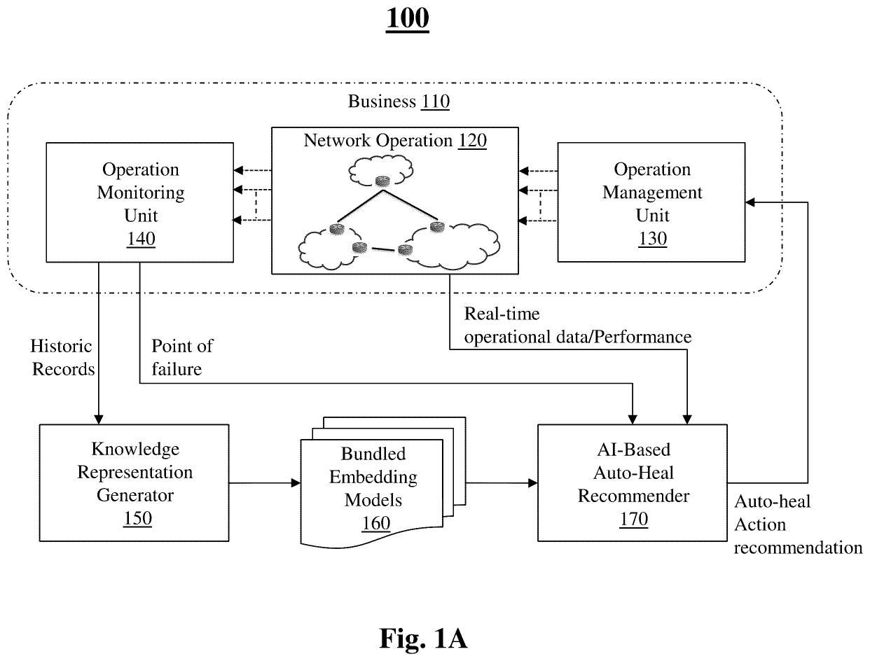

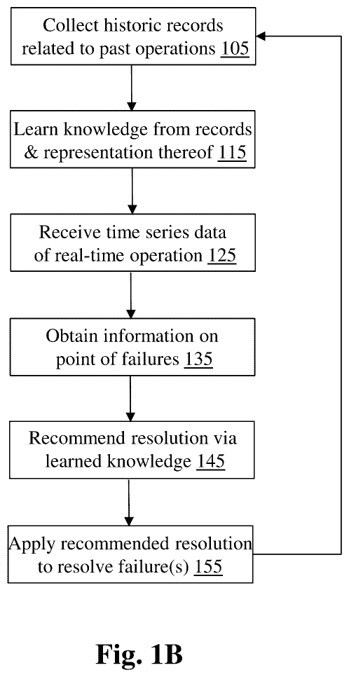

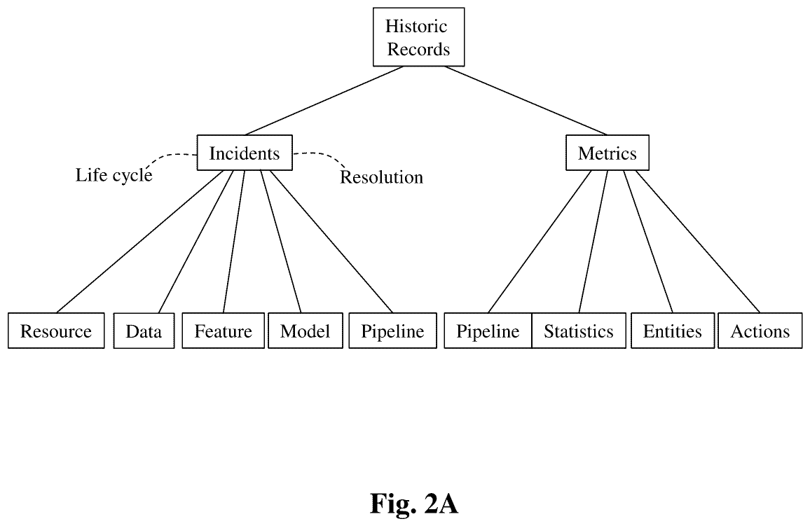

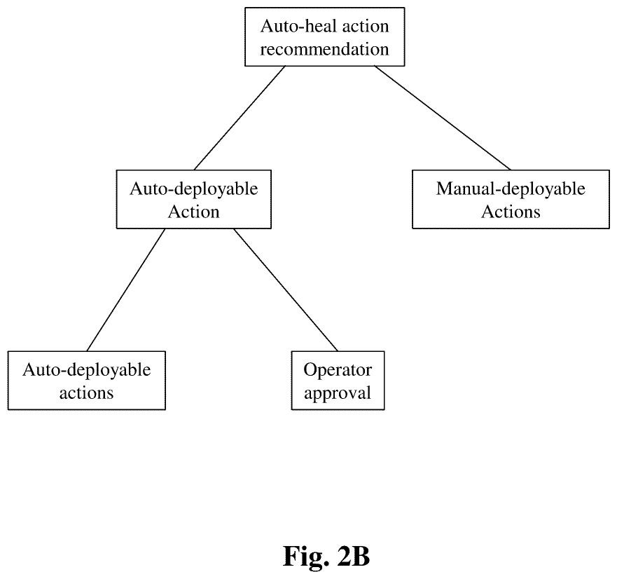

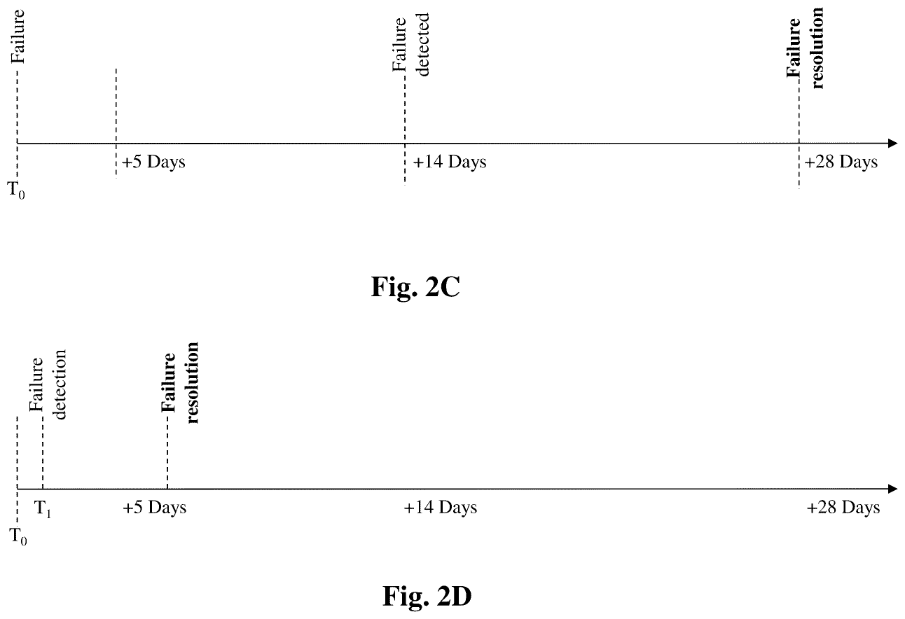

FIG. 1A depicts an exemplary framework 100 for AI-enabled network auto-healing, in accordance with an embodiment of the present teaching. The exemplary framework 100 comprises a business 110, a knowledge representation generator 150, and an AI-based auto-heal recommender 170. In this illustrated embodiment, the business 110 is conducted via a network operation 120, which is managed by an operation management unit 130 and its performance is monitored by an operation monitoring unit 140. The operation monitoring unit 140 may create historic records which include, e.g., not only performance of the network operation 120 but also operational data recording, e.g., what is done, what effect achieved, that are either collected automatically during the operation or recorded by system operators/engineers. FIG. 2A illustrates exemplary types of information that may be included in historic records related to the network operation 120, in accordance with an embodiment of the present teaching. As shown, historic records may include various metrics related to different aspects of the network operation 120 including its pipelines, its performance statistics, connected entities, and actions taken to address different issues. The historic records may also include reports on various incidents occurred in terms of resources, data, features, models, and pipelines of the network operation 120, where a report on each of the incidents may include textual descriptions on the symptoms of the incident, chain impact of the incident on different network components, one or more resolutions deployed to address the effect thereof, and/or information on the life cycle thereof. The life cycle of each incident may involve a process of resolving a failure with a successful conclusion and optionally unsuccessful attempts prior thereto. With such information collected, historic records may represent accumulated knowledge that may be captured, via machine learning, in AI-based models to enable automatic resolution recommendation.

FIG. 1B is a flowchart of an exemplary process for the AI-enabled network auto-healing framework 100, in accordance with an embodiment of the present teaching. The operation monitoring unit 140 may collect, at 105, information related to the performance of the network operation 120 and provide historic records to the knowledge representation generator 150 for knowledge learning, at 115, from such historic records via machine learning to generate bundled embedding models 160 in accordance with the present teaching. With such bundled embedding models 160, when the AI-based auto-heal recommender 170 receives, at 125, the real time series data associated with the network operation 120 as well as, at 135, information on a point of failure from the operation monitoring unit 140, it recommends, at 145, resolutions to address a given failure at the point of failure in accordance with the learned bundled embedding models 160 that captures the knowledge/experience from past operations. The recommended resolution(s) may then be applied, at 155, by the operation management unit 130 to carry out the recommended measures in the network operation 120 to resolve the failures.

FIG. 2B illustrates exemplary types of resolutions automatically recommended based on knowledge learned from historic records, in accordance with an embodiment of the present teaching. The recommended resolutions are based on learned knowledge that is captured in the bundled embedding models 160 and resolutions deployed previously, e.g., those resolutions to remedy different points of failures in the network that may include both measures that may correspond to either automatically implemented actions and/or some actions that may need manual deployment. Given that, the automatically recommended resolutions to address certain network failures may also involve either automatically deployable actions or manually deployable actions. In operation, some of the recommended automatically deployable actions may be directly activated and some may need approval from network operator or management.

The resolution recommendation capability of the framework 100 according to the present teaching facilitates enhanced performance in terms of MTTD and MTTR. FIGS. 2C and 2D show comparison between performance timeline of a traditional network and that of the framework 100 for resolving a network failure according to the present teaching. As shown in FIG. 2C, with a traditional network, when a pipeline failure occurs at time T₀, it usually takes an average of several days (e.g., 5 days) to escalate on insights non availability and then more time to open a generic incident investigation on operations excellence triaging. It may take another two weeks (14 days) from T₀ to detect the type of failure, i.e., MTTD=14 days. It usually takes an equal number of days (14 days) to reach a resolution to address the failure, i.e., MTTR=28 days. The illustrated performance of the framework 100 with the AI-enabled auto-heal resolution recommendation is exemplified in FIG. 2D. For a pipeline failure occurring at T₀, based on the bundled embedding models 160 capturing knowledge from the past operations, the type of failure is detected at T₁, e.g., less than one hour from the occurrence of the failure, i.e., MTTD<=1 hour, to predict the pipeline breakage due to the failure based on the bundled embedding models 160 that may predict the type of failure based on what is observed from the real-time operational data and performance information as well as the past knowledge captured therein. The time series data in the real time data may be relied on to recommend a resolution based on the context of the network operation and a typical period of generating the recommendation is a few days such as 5 days. That is, with the framework according to the present teaching, MTTR is much shorter as compared to that of a traditional framework.

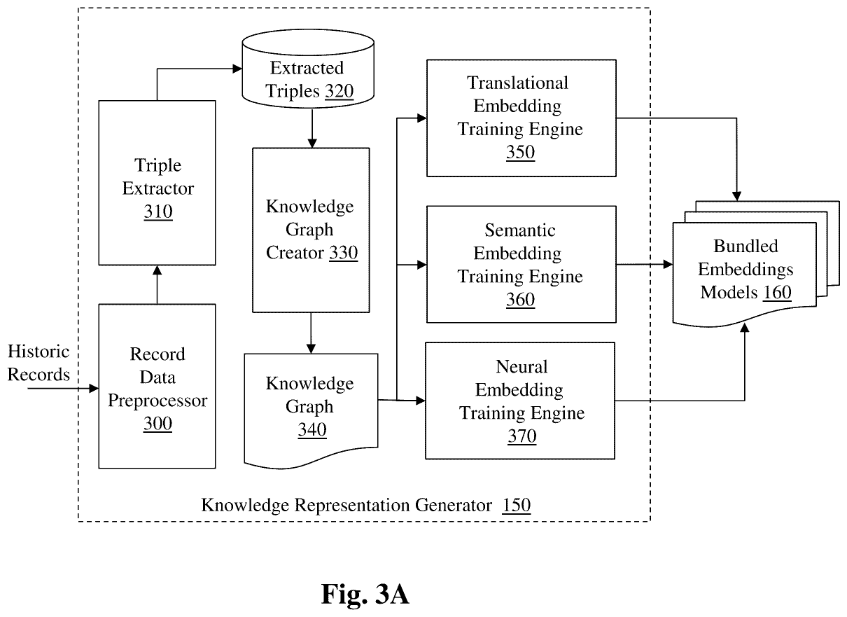

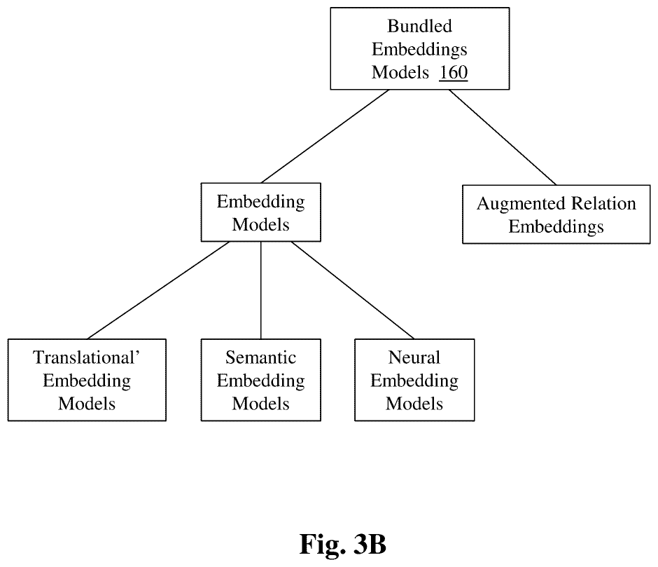

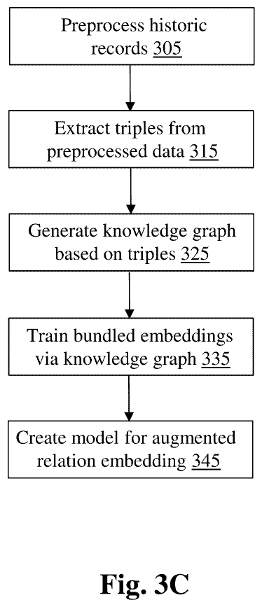

FIG. 3A depicts an exemplary high level system diagram of the knowledge representation generator 150, in accordance with an embodiment of the present teaching. As discussed herein, the knowledge representation generator 150 is provided for learning, from historic records, accumulated knowledge from past operations to obtain the bundled embedding models 160 to capture such knowledge so that the models may be applied to real time network operational data to make predictions of failures occurred to enable resolution recommendations. In this illustrated embodiment, the knowledge representation generator 150 comprises two parts, where the first part is provided to learn knowledge from historic records and represent such knowledge in the form of a knowledge graph 340. The second part is provided for constructing one or more embedding models based on the knowledge graph, each of which may be obtained to capture the information represented in the knowledge graph from different perspective. These one or more embedding models may be used together forming bundled embedding models 160.

The first part includes a record data preprocessor 300 for preprocessing the historic records received, a triple extractor 310 for identifying linked network components from the historic records, and a knowledge graph creator 330 for constructing the knowledge graph 340 based on the triples extracted from the historic records. As discussed herein, in some embodiments, the historic records include incident management book of records that may house semi-structured data with resolutions applied to address a failure and comments from, e.g., network operators or management team, on the effectiveness of the resolutions. Such comments may be provided as unstructured text. Given that, the record data preprocessor 300 may perform processing on the text, e.g., natural language processing (NLP) to identify different portions of the text, such as entities or relations, from the unstructured or semi-structured text. This facilitates the extraction of triples (discussed below) to enable the construction of the knowledge graph 340.

Triples may be identified by the triple extractor 310 from past records and stored in a storage 320 for extracted triples. Each triple is a basic building block of causal relation representing something happened to some entity in the network at some point of time that caused some direct impact to another entity. Formally, a triple is defined as a three-element tuple [e1, r, e2], where e1 and e2 correspond two entities in a set E of entities, and r represents a causal relation in a set R of relations. Entity e1 may represent a head entity in this relation and entity e2 represents a tail entity, which form an atomic causal relation, denoted by r. The triples in the historic records capture different types of information. For example, a head entity e1 may be “pipeline port-out,” a tail entity e2 may be “platform pipelines,” and a relation r may be “failed,” so that triple [e1, r, e2] may indicate that because the pipeline port is out of order, it caused the failure of platform pipelines. In some applications, entity set E may include, e.g., pipelines, data products, incidents, data, platform pipelines, etc. relation set R may include, e.g., succeeded, failed, dependent, healing, extracts, loads, and create, etc.

Information from the historic records may be time stamped. As such, triples extracted from historic records may also be associated with time stamps. The timed triples may form a chain of causal relations, representing a chain of events, which may represent a chain effects on different components when a failure occurred at some point of a network. Such a chain effect across different components of a network may be captured via machine learning based on timed triples. For example, if a triple with a time stamp at T₁ is [signal-flow, misfunction, data error], a triple with a next time stamp at T₂ is [data error, dependent, loss packet], and a triple with a next time stamp at T₃ is [loss packet, dependent, breakdown], these three triples form a chain of causal events. Such information may be used by the knowledge graph creator 330 to construct the knowledge graph 340, where each chain of events among different network entities may form a path in therein. A series of resolution steps that were taken historically to fix failures occurred in the past in a network may also be represented in the knowledge graph 340. Similarly, the impact of a resolution may correspond to a reversed causal chain, which may also be captured in the knowledge graph 340.

The knowledge graph 340 generated based on triples may capture what occurred in a network historically, including observations on entities, relations spread across different entities, problem-driven resolutions adopted, causal or chain effect of such resolutions, and the consequential performances. In some situations, the knowledge graph 340 may include triples that have missing elements. For example, a triple [?, r, t] may represent a triple with relation r and tail entity t with the head entity h missing; [h, ?, t] represents a triple with the relation element missing; a triple [h, r, ?] represents a triple with the tail entity missing. Such missing elements may be predicted by embedding models as to be discussed below in the learning process. Although with some missing elements, the knowledge graph 340 represents the past network dynamics characterized by the historic records may then be used for learning the knowledge captured therein. The network dynamics represent the operational status of the network at different time instances. As each triple records states of some network components at those time instances as well as connections among the triples linked based on, e.g., time stamps. With the continuing collected historic records, the knowledge graph 340 may gradually be made more complete over time.

In this illustrated embodiment, the second part of the knowledge representation generator 150 is provided to learn bundled embedding models 160, including, e.g., a translational embedding model, a semantic embedding model, and a neural embedding model. A knowledge graph embedding model is used to identify missing entities and relationships based on the graph. Depending on the nature of different relationships (e.g., symmetric, asymmetric, reciprocal, inversion, etc.), different embedding models may be used to capture corresponding relationships. As such, to facilitate that, the second part comprises a translational embedding training engine 350, a semantic embedding training engine 360, and a neural embedding training engine 370 to obtain a translational embedding model, a semantic embedding model, and a neural embedding model, respectively. A translational embedding model may be used to learn vector representations of entities and relations by treating relations as translation operators over the entities in an embedding space. A semantic embedding model may be used to learn the meaning of text expressed in the textual content. A neural embedding model may be used to reduce the dimensionality of categorical variables in order to represent categories in a transformed space in a meaningful fashion. Applying such embedding models to the knowledge graph as developed based on triples constructed according to the present teaching, the learned translational embedding model may be used to identify valid triples further from a knowledge graph post treating translational operators in an embedding space. The semantic embedding model obtained via training may be used to identify valid triples from a knowledge graph via a search based on similarity semantics. The neural embedding model may be used to ascertain missing triples via deep learning.

In addition to the exemplary types of embedding models, the bundled embedding models 160 may also include an embedding model for augmented relations. FIG. 3B shows these exemplary types of embedding models as discussed herein in the bundled embedding models 160, in accordance with an embodiment of the present teaching. The augmented relation embeddings may be a specified manner, by which translational embeddings obtained via the translational embedding model, semantic embeddings obtained via the semantic embedding model, and neural embeddings obtained via the neural embedding model may be integrated to produce combined embeddings. In some embodiments, the augmentation may be specified as an average of different embeddings (e.g., a dot product of three feature vectors). In some embodiments, the augmentation may be specified as the maximum of the embeddings considered. The integration scheme may be defined according to the need of different applications.

FIG. 3C is a flowchart of an exemplary process of the knowledge representation generator 150, in accordance with an embodiment of the present teaching. Upon receiving the historic records, the record data preprocessor 300 preprocesses, at 305, these historic records. In some embodiments, such preprocessing may involve natural language processing of textual description in the incident management book of records and identifying, e.g., relevant entities corresponding to network components or actions taken, or outcome of associated actions. The preprocessed historic records are then used by the triple extractor 310 extracts, at 315, triples and stores them in storage 320. The knowledge graph creator 330 accesses the stored triples in 320 and generates the knowledge graph 340. As discussed herein, the knowledge graph 340 captures the dynamics and knowledge of past records related to a network operation and is used for training, at 335, different embedding models. Specifically, the translational embedding training engine 350 trains a translational embedding model; the semantic embedding training engine 360 trains a semantic embedding model; and the neural embedding training engine 370 trains a neural embedding model.

In addition, a model for generating augmented relation embeddings based on translational/semantic/neural embedding models may be created at 345 as also part of the bundled embedding models 160. Such generated bundled embedding models may then be used by the knowledge-based auto-heal recommender 170 (see FIG. 1A) to automatically recommend resolutions to be adopted with respect to some given failures at reported points of failure based on real time operational data of the network operation 120.

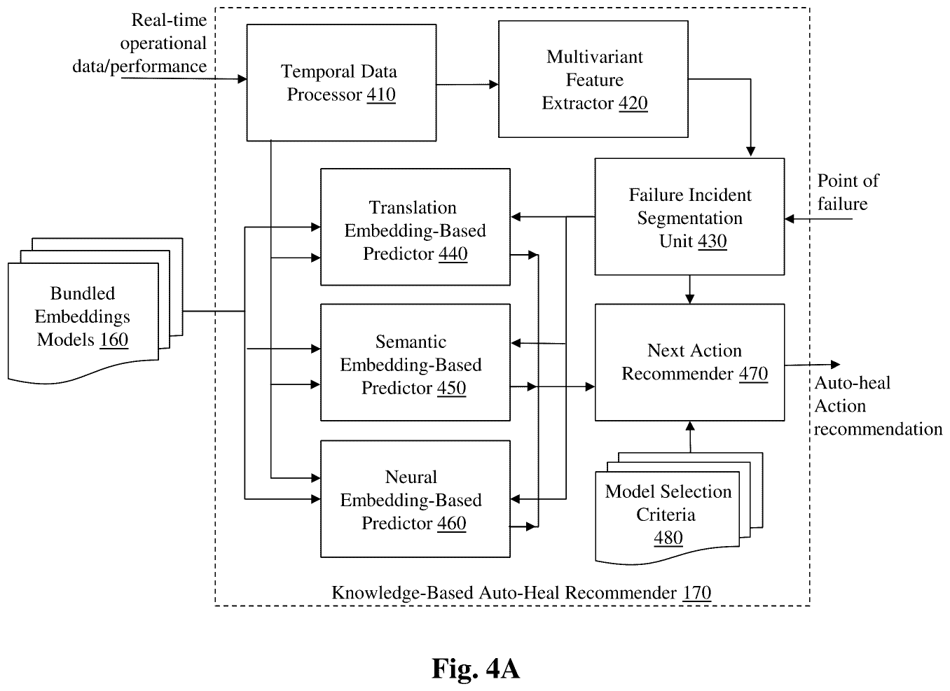

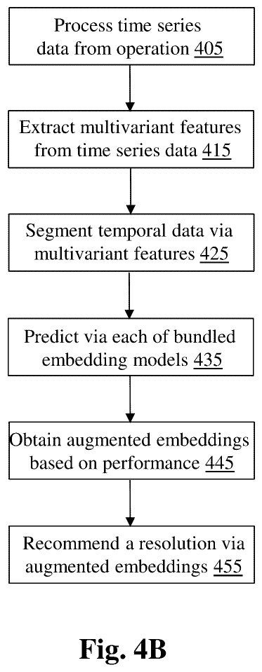

FIG. 4A depicts an exemplary high level system diagram of the knowledge-based auto-heal recommender 170, in accordance with an embodiment of the present teaching. As discussed herein, the knowledge-based auto-heal recommender 170 receives real time operational data from the network operation 120 and the data on points of failure from the operation monitoring unit 140 and outputs an auto-heal recommendation in accordance with the bundled embedding models 160. In this illustrated embodiment, the knowledge-based auto-heal recommender 170 comprises a temporal data processor 410, a multivariant feature extractor 420, a failure incident segmentation unit 430, a translational embedding-based predictor 440, a semantic embedding-based predictor 450, a neural embedding-based predictor 460, and a next action recommender 470.

FIG. 4B is a flowchart of an exemplary process for the knowledge-based auto-heal recommender 170, in accordance with an embodiment of the present teaching. When the real time operational data related to the network operation 120 is received, the temporal data processor 410 processes, at 405, the time series data so that the multivariant feature extractor 420 may then extract, at 415, multivariant features which may characterize the time series data. In some embodiments, the temporal data may be processed so that it is more appropriate for further analysis. For instance, data smoothing may be applied to remove noise. When the failure incident segmentation unit 430 receives information relating to a point of failure, it segments, at 425, the temporal data associated therewith based on, e.g., the multivariant features from 420. The segmented information may provide context around a failure incident at the point of failure. Such contextual information segmented based on the real time operational data may not be complete or accurate but may be used by the bundled embedding models to predict the missing information. For example, if the real time data reveals signal-flow and data error, a triple [signal-flow, malfunction, data error] may be predicted based on different embedding models trained based on knowledge graph 340 that captures the triple from historic records. In this example, the misfunction is a predicted link based on an embedding model.

This is shown in FIG. 4A, where the segmentation result from the failure incident segmentation unit 430 is provided to predictors 440, 450, and 460 to predict a next best action, each from a different perspective learned based on previous training. In this illustrated embodiment, the previously trained translational embedding model, semantic embedding model, and neural embedding model are used respectively for the prediction at 435. The predicted best action from different embedding models may then be provided to the next action recommender 470, which may select, at 445, an appropriate (e.g., the best) embedding model based on some predetermined model selection criteria 480. In some embodiment, an embedding model may be selected based on an evaluation of respective performance of individual models using some score functions, which may be indicative of the accuracy of the triples predicted. For example, a hit ratio (HR) may be used as a performance metric representing the number of best actions that are used in incident resolution. In another example, a mean reciprocal rank (MRR) may be adopted which represents a ranked list of next best actions predicted. The selected embedding model may then be used to generate a recommended resolution at 455.

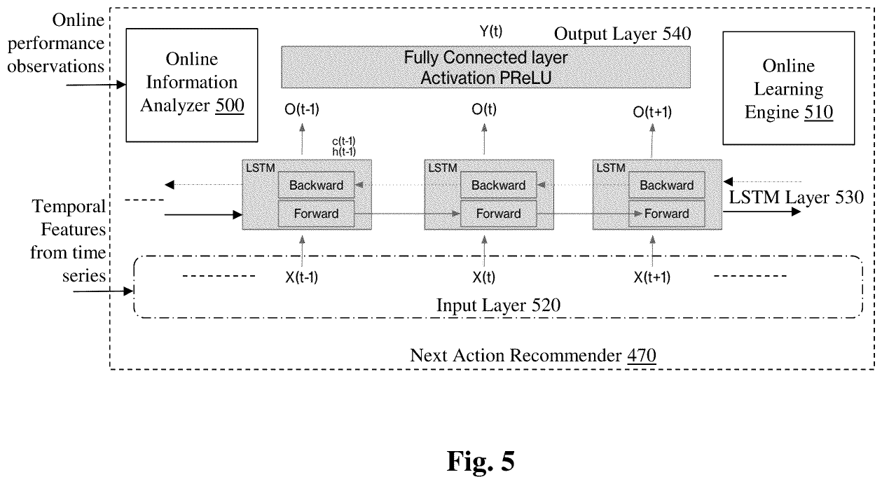

As discussed herein, the next action recommender 470 receives inputs from embedding models in the bundled embedding models as well as some performance information monitored on-the-fly, etc. and determines the efficient embedding model that has augmented relations best facilitating the next best action. In some embodiments, the next action recommender 470 may be implemented using a memory enabled ANN, such as recurrent neural network (RNN) with bidirectional memory capacities such as RNN bidirectional long short term memory (LSTM) with parameterized rectified linear unit (PReLU). FIG. 5 shows an exemplary implementation of the next action recommender 470 based on RNN PRELU Bi-directional LSTM, in accordance with an embodiment of the present teaching. In this illustrated embodiment, the next action recommender 470 comprises an online information analyzer 500, an online learning engine 510, and an ANN constructed using RNN PReLU bidirectional LSTM with an input layer 520, an LSTM layer 530, and a fully connected output layer 540 with activation PRELU. The online information analyzer 500 may be provided to take pipeline information observed on-the-fly and analyze the data to facilitate the selection of an embedding model with best prediction performance to best fit the observed pipeline events. For example, based on the online observation, the online information analyzer 500 may determine certain metrics that may be used to select dynamically an embedding model as a source of the input layer 520.

The input layer 520 may be provided to take input from an embedding model selected based on the analysis result from the online information analyzer 500. The outputs from the selected embedding model may be received by the input layer 520 as a time series, e.g., a sequential input at time x(t−1), x(t), x(t+1), . . . etc. The input at each time is provided to a corresponding cell in the LSTM layer 530, where cells in the LSTIM layer 530 are chained in both forward and backward directions. Each of the cells in the LSTM layer 530 produces its output, e.g., o(t−1), o(t), o(t+1), . . . , etc., as a result of the contextual information represented in the time series, as shown in FIG. 5. The outputs from individual cells of the LSTM layer 530 are then provided to the output layer 540, a fully connected layer with activation PRELU to produce an output y(t) representing a recommended resolution at time t, which is a result of considering the temporal data not only at time t but also information at times at both backward and forward time instants. Thus, this exemplary implementation with an LSTM mechanism is to carry out time series predictions based on embedding model(s) selected based on continuously observed network data.

The online learning engine 470 may be provided to carry out online learning of recommending resolution based on actual network performance information monitored on-the-fly. In some embodiments, the received online information may include network performance data. To enable learning based on online performance, the received performance data (e.g., metrics) may be incorporated in some loss function(s) associated with the training of the ANN architecture as illustrated in FIG. 5. The input layer 520, the LSTM layer 530, and the output layer 540 may be constructed with learnable parameters whose values may determine the performance of the ANN and may be adjusted during learning to minimize the prediction errors. In online learning, the discrepancy between received performance metrics and the predicted recommendation may be used to determine how to adjust the values of learnable parameters in different layers by minimizing the loss function(s).

The bidirectional LSTM according to the present teaching facilitates flexibility to include best performing embedding model in each run via updated cell state. At the same time, it allows the forget gate updated so as to move out next best actions that are inaccurate. This enables applicability during re-processing and re-runs. Network features used by the LSTM are directly monitored from the network operation, including network KPI, customer KPI, monitored observability metrics such as tracked signals across platforms and applications, evaluation metrics on previously deployed best actions to remedy past failures, as well as scoring metrics provided by human operators in the loop. As the knowledge graph according to the present teaching is constructed based on triples formed from such monitored network features to characterize network entities and relations thereof, the automatically produced recommendations according to the present teaching to remedy failures at certain points of failure of network operation are explainable.

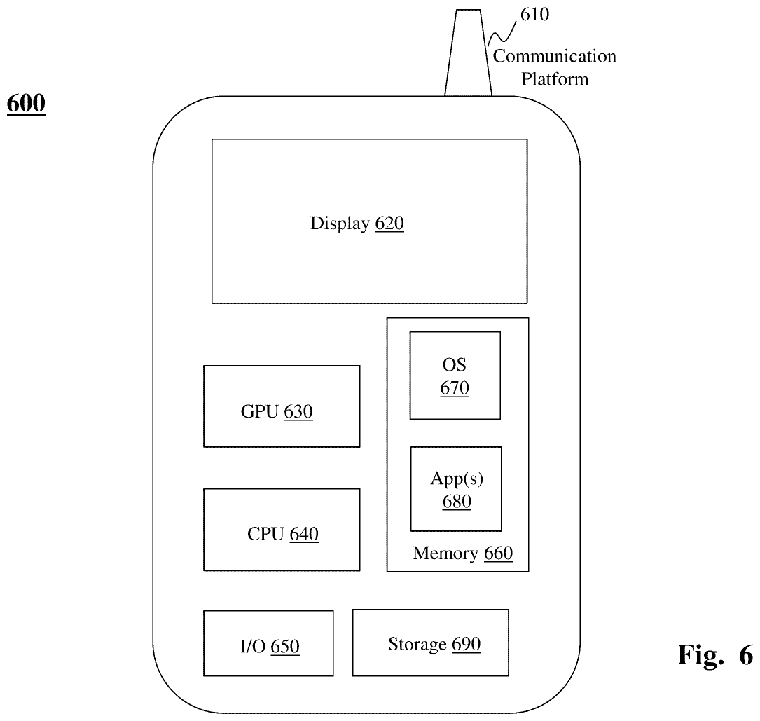

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 800, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 in order to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

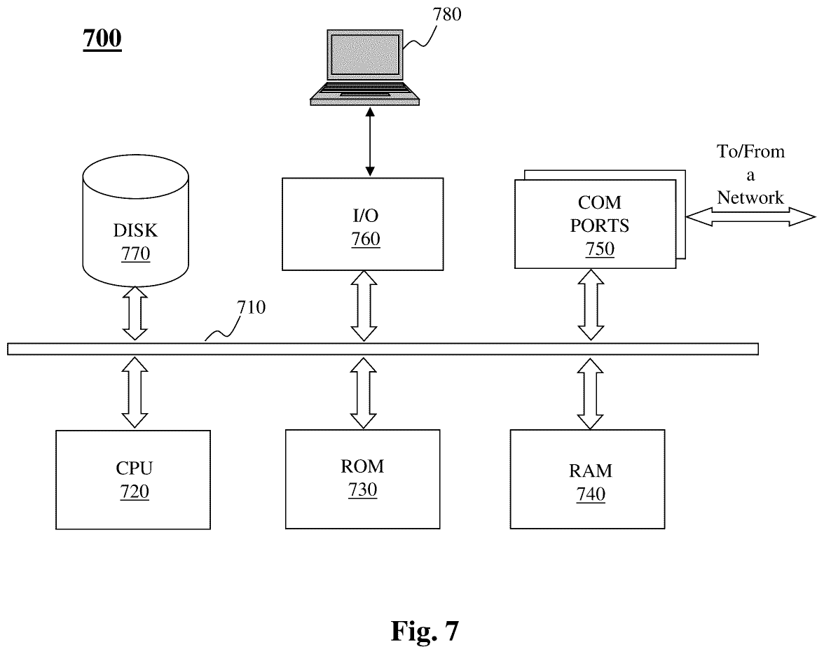

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
receiving historic records representing knowledge on past dynamics of a network with information on performance of the network, incidents occurred with corresponding resolutions, and monitored feedback on effectiveness of each of the resolutions;
obtaining, via machine learning, bundled embedding models based on the information from the historic records, wherein each of the bundled embedding models captures a respective aspect of the knowledge;
receiving real time temporal data collected during operation of the network, wherein the temporal data includes observations on the network, metrics characterizing performance thereof, and a point of failure;
deriving embeddings of the temporal data with respect to the point of failure in accordance with the bundled embedding models;
generating, via time series forecast, an auto-heal recommendation of a resolution with respect to the point of failure based on the embeddings;
receiving performance information associated with the network at the point of failure;
performing online learning of a plurality of learnable parameters associated with the time series forecast based on the performance information.

2. The method of claim 1, wherein the bundled embedding models include:
a translational embedding model;
a semantic embedding model; and
a neural embedding model.

3. The method of claim 1, wherein the obtaining the bundled embedding models comprises:
processing the historic records via natural language processing;
constructing a knowledge graph based on a plurality of triples extracted from the historic records, wherein each of the plurality of triples specifies two entities in the network associated therewith in accordance with a relation;
training, via machine learning, the bundled embedding models based on the knowledge graph.

4. The method of claim 3, wherein the constructing the knowledge graph comprises:
identifying, from the processed historic records, entities, relations, and time stamps associated therewith;
extracting the plurality of triples based on the time stamped entities and relations;
linking at least some of the plurality of triples based on time stamps associated with each of the plurality of triples;
creating the knowledge graph based on the plurality of triples and links connected the at least some of the plurality of triples.

5. The method of claim 1, wherein the deriving embeddings of the temporal data comprises:
selecting one of embedding models from the bundled embedding models based on a predetermined criterion specified in accordance with one or more performance metrics; and
obtaining the embeddings of the temporal data with respect to the point of failure based on the selected embedding model.

6. The method of claim 1, wherein the generating an auto-heal recommendation comprises:
receiving the embeddings generated with respect to temporal data collected at multiple time instances;
performing time series forecast based on the embeddings of the temporal data via a recurrent neural network (RNN) with bidirectional long short term memory (BiLSTM) to generate a prediction;
outputting the prediction as the auto-heal recommendation of a resolution to address the failure occurring at the point of failure.

7. The method of claim 1, wherein the performing online learning comprises:
analyzing the performance information monitored with respect to the point of failure;
determining, with respect to each of the plurality of learnable parameters, an adjustment to a current value of the learnable parameter based on the auto-heal recommendation and the performance information;
adjusting the value of each of the learnable parameters according to the corresponding determined adjustment.

8. A machine-readable and non-transitory medium having information recorded thereon, wherein the information, when read by the machine, causes the machine to perform the following steps:
receiving historic records representing knowledge on past dynamics of a network with information on performance of the network, incidents occurred with corresponding resolutions, and monitored feedback on effectiveness of each of the resolutions;
obtaining, via machine learning, bundled embedding models based on the information from the historic records, wherein each of the bundled embedding models captures a respective aspect of the knowledge;
receiving real time temporal data collected during operation of the network, wherein the temporal data includes observations on the network, metrics characterizing performance thereof, and a point of failure;
deriving embeddings of the temporal data with respect to the point of failure in accordance with the bundled embedding models;
generating, via time series forecast, an auto-heal recommendation of a resolution with respect to the point of failure based on the embeddings;
receiving performance information associated with the network at the point of failure;
performing online learning of a plurality of learnable parameters associated with the time series forecast based on the performance information.

9. The medium of claim 8, wherein the bundled embedding models include:
a translational embedding model;
a semantic embedding model; and
a neural embedding model.

10. The medium of claim 8, wherein the obtaining the bundled embedding models comprises:
processing the historic records via natural language processing;
constructing a knowledge graph based on a plurality of triples extracted from the historic records, wherein each of the plurality of triples specifies two entities in the network associated therewith in accordance with a relation;
training, via machine learning, the bundled embedding models based on the knowledge graph.

11. The medium of claim 10, wherein the constructing the knowledge graph comprises:
identifying, from the processed historic records, entities, relations, and time stamps associated therewith;
extracting the plurality of triples based on the time stamped entities and relations;
linking at least some of the plurality of triples based on time stamps associated with each of the plurality of triples;
creating the knowledge graph based on the plurality of triples and links connected the at least some of the plurality of triples.

12. The medium of claim 8, wherein the deriving embeddings of the temporal data comprises:
selecting one of embedding models from the bundled embedding models based on a predetermined criterion specified in accordance with one or more performance metrics; and
obtaining the embeddings of the temporal data with respect to the point of failure based on the selected embedding model.

13. The medium of claim 8, wherein the generating an auto-heal recommendation comprises:
receiving the embeddings generated with respect to temporal data collected at multiple time instances;
performing time series forecast based on the embeddings of the temporal data via a recurrent neural network (RNN) with bidirectional long short term memory (BiLSTM) to generate a prediction;
outputting the prediction as the auto-heal recommendation of a resolution to address the failure occurring at the point of failure.

14. The medium of claim 8, wherein the performing online learning comprises:
analyzing the performance information monitored with respect to the point of failure;
determining, with respect to each of the plurality of learnable parameters, an adjustment to a current value of the learnable parameter based on the auto-heal recommendation and the performance information;
adjusting the value of each of the learnable parameters according to the corresponding determined adjustment.

15. A system comprising:
a knowledge representation generator implemented by a processor and configured for:
receiving historic records representing knowledge on past dynamics of a network with information on performance of the network, incidents occurred with corresponding resolutions, and monitored feedback on effectiveness of each of the resolutions,
obtaining, via machine learning, bundled embedding models based on the information from the historic records, wherein each of the bundled embedding models captures a respective aspect of the knowledge; and
an artificial intelligence (AI) based auto-heal recommender implemented by a processor and configured for:
receiving real time temporal data collected during operation of the network, wherein the temporal data includes observations on the network, metrics characterizing performance thereof, and a point of failure,
deriving embeddings of the temporal data with respect to the point of failure in accordance with the bundled embedding models,
generating, via time series forecast, an auto-heal recommendation of a resolution with respect to the point of failure based on the embeddings,
receiving performance information associated with the network at the point of failure, and
performing online learning of a plurality of learnable parameters associated with the time series forecast based on the performance information.

16. The system of claim 15, wherein the bundled embedding models include a translational embedding model, a semantic embedding mode, and a neural embedding model, wherein the obtaining the bundled embedding models comprises:
processing the historic records via natural language processing;
constructing a knowledge graph based on a plurality of triples extracted from the historic records, wherein each of the plurality of triples specifies two entities in the network associated therewith in accordance with a relation;
training, via machine learning, the bundled embedding models based on the knowledge graph.

17. The system of claim 16, wherein the constructing the knowledge graph comprises:
identifying, from the processed historic records, entities, relations, and time stamps associated therewith;
extracting the plurality of triples based on the time stamped entities and relations;
linking at least some of the plurality of triples based on time stamps associated with each of the plurality of triples;
creating the knowledge graph based on the plurality of triples and links connected the at least some of the plurality of triples.

18. The system of claim 15, wherein the deriving embeddings of the temporal data comprises:
selecting one of embedding models from the bundled embedding models based on a predetermined criterion specified in accordance with one or more performance metrics; and
obtaining the embeddings of the temporal data with respect to the point of failure based on the selected embedding model.

19. The system of claim 15, wherein the generating an auto-heal recommendation comprises:
receiving the embeddings generated with respect to temporal data collected at multiple time instances;
performing time series forecast based on the embeddings of the temporal data via a recurrent neural network (RNN) with bidirectional long short term memory (BiLSTM) to generate a prediction;
outputting the prediction as the auto-heal recommendation of a resolution to address the failure occurring at the point of failure.

20. The system of claim 15, wherein the performing online learning comprises:
analyzing the performance information monitored with respect to the point of failure;
determining, with respect to each of the plurality of learnable parameters, an adjustment to a current value of the learnable parameter based on the auto-heal recommendation and the performance information;
adjusting the value of each of the learnable parameters according to the corresponding determined adjustment.
